(19) United States
(12) Patent Application Publication
(10) Pub. No.: US 2021/0010205 A1
(43) Pub. Date: Jan. 14, 2021

(54) RAIL BOLT LOCKING DEVICE

(71) Applicants: Ifor C. DAVIES, Oakville (CA); Lori D. MAGUIRE, Oakville (CA)

(72) Inventors: Ifor C. DAVIES, Oakville (CA); Lori D. MAGUIRE, Oakville (CA)

(21) Appl. No.: 17/040,705

(22) PCT Filed: Apr. 5, 2019
(86) PCT No.: PCT/CA2019/050420

§ 371 Date: Sep. 23, 2020

Related U.S. Application Data
(60) Provisional application No. 62/654,569, filed on Apr. 9, 2018.

(51) Int. Cl. E01B 11/38; F16B 39/10

(52) U.S. Cl. CPC E01B 11/38; F16B 39/101

(57) ABSTRACT

A rail bolt nut locking device comprising a member having a first planar section at one end of the member, and a second planar section at an opposite end of the member, a central, curved intermediate section located between the planar sections. The first and second planar sections are substantially flat but include openings which are adapted to be friction fitted around the nuts of rail bolts which have been used to hold a frog or rail joint bar in place on a railway rail. The intermediate section is preferably made of a resilient plastic, to allow relative movement of the first and second planar sections. The planar sections, when fitted to the rail bolts, prevents loosening of the rail bolt nuts, and the curved intermediate section can act to prevent the rail bolts from backing out of the openings provided for the rail bolts. A device and method to lock the rail bolts in place is provided.

### FIELD OF THE INVENTION

The present invention relates to the field of rail line joint bars and frogs, and in particular, relates to a safety device that is used to lock in place the rail bolt nuts which secure the bolts that are used to attach the joint bars and frogs, to the rail. The locking device can also be used to indicate rotational movement of the rail bolts.

### BACKGROUND OF THE INVENTION

Railway tracks typically consist of parallel lines of rails which rails are held in place by attachment of the foot of the rail to a railway tie, sleeper, or the like. Rails are typically made of steel, and are provided in various lengths. In order to provide the extended length necessary on the railway line, the end of a rail section is attached to the end of an adjacent rail section. These sections can be welded together to form an extended rail. However, many rail sections are connected together using joint bars (also called “fishplates”) positioned on each side of the rail. In use, the joint bars are positioned so that they cover the ends of both sections of adjacent rails, and the assembly is bolted together, through the joint bars and the web section of the rail, by use of rail bolts (also called “fish bolts”). The combination of joint bars bolted to the ends of adjacent rails, acts to hold the ends of the adjacent rail sections in alignment, and prevents the rails from moving or coming out of alignment.

The joint bars are thus held in place on the sides of the rail in a position where they are at the sides of the rail, but below the top of the railhead portion of the rail. As such, they join rail sections, without interfering with the wheels of the rail cars passing along the rail.

Joint bars can also provide electrical connectively between rails, and/or provide joints for the connection of rails of different sizes or gauges.

In a related manner, “frogs” or “frog bars” are also used in railway track assembly in turnout or switch areas where the train switches or crosses from one rail line to another. The frog is a collection of pieces that allow one track to cross another while providing an opening for the wheel flange to pass through. Typically, the frog includes a “V”-shaped rail section, and the frog is typically of rails or rail sections having the same cross-sectional profile as those rails used in the track. The frog can be one complete component, or it can be built up from a series of components. The frog is typically held in place by being bolted to the end of the rail using a joint bar connection, as discussed hereinabove, and/or by providing sections on the frog itself which are adapted receive the ends of the rail, and allow the frog to be bolted to the end sections of the rail, using additional rail bolts.

However, over time, the nuts of the rail bolts on joint bars and frogs can be loosened by various causes, including vibration in the rail, movement of the rail caused by the weight of the passing rail cars, temperature expansion and contraction, and the like. Additionally, contaminants lodged between the rail bolt nuts, the rails, the frog, and the joint bar surface, and the like, can prevent proper seating of the nut which can lead to loosening of the nut when the contaminant breaks free. As such, there are a variety of reasons why a rail bolt nut will loosen over time.

Moreover, loosening of one rail bolt nut also can lead to loosening of adjacent rail nuts, and this effect can cause all of the rail bolts to become loosened as the forces acting on the loosening rail bolt are transmitted to adjacent rail bolts. This loosening of one or more rail bolts can cause weakening of the rail end joint, which can lead to the frog becoming loose, the joint separating, or even causing breakage of the joint bars due to excessive movement under heavy loads. Typically, the train operator has little or no warning of these types of failures, and thus, a failure of the frog or joint bar can lead to derailment of the railway cars and the resultant significant damage. As a consequence, it is necessary to constantly monitor and check that the nuts on the rail bolts are sufficiently tight, and have not loosened over time. However, detection of loosening rail bolts is difficult to observe from a moving train. Even with visual inspections from the ground, the initial stages of a loosening rail bolt nut can be difficult to detect. As a result, rail bolt nut tightness is commonly tested by merely using a wrench to see if the nut is still tight.

The constant need for testing of the tightness of the rail bolt is therefore, a significant maintenance issue for all railways.

Joint bars, including splice, full toe and short toe versions, are typically made of steel, and have a typical length of 2 or 3 feet (300 to 450 cm). They commonly have four or six bolt holes which holes are configured to be in alignment with holes provided in the rail web section at or near the end of the rails. Two or three bolt holes are normally provided on each end of the rail for just this purpose, and these holes are positioned so as to align with the holes on the joint bars.

Once the rails are in place, and the joint bars are positioned on each side of the rail sections, rail bolts are inserted through the holes in the rail and joint bars. The entire assembly is tightened together by tightening all of the rail bolt nuts, using a wrench. Once tightened, the joint bars keep the rail ends together, and in alignment.

Frogs are typically held together by, or connected to the end of the rail section, by use of a series of rail bolts and nuts. Typically, the rail bolts are closer together in the frog, than they would be for a joint bar, and the nuts are typically all located on the same side.

Various types of rail bolts for use in these applications are known. In one example, the rail bolt can have square or hexagonal heads at a first end of the rail bolt. In another version, the first end of the rail bolt has a rounded end (similar to a carriage bolt) with an oval or square shoulder. Either type of rail bolt can include a square or oval shoulder which can be mated with a square or oval shaped opening in the joint bar, in order to prevent rotation of the rail bolt once it has been fully inserted into the rail and joint bar sections.

At the second end of the rail bolt, a threaded section is provided which is adapted to receive a square or hexagonal shaped nut, which can be tightened onto the rail bolt, using a suitable wrench. A lock washer can also be included in this arrangement, if desired.

In some applications, all of the bolt heads are located on the same side of the rail, and the present invention can be used in this type of bolt head arrangement on adjacent nuts. More recently, however, an alternating rail bolt pattern is commonly used wherein the rail bolts are inserted in a manner that the rail bolt heads alternate from side to side of the rail. As a result, the nuts for adjacent rail bolts, have to be located on opposite sides of the rail. In this arrangement, two nuts are therefore located on each side of a four-hole joint bar, and three nuts are located on each side of a six-hole joint bar.

Various devices have been proposed to prevent loosening of the rail bolts and/or to provide feedback to a train operator or maintenance crew that a rail bolt is loosening on a frog or joint bar. These include, for example, approaches that use a steel frame which is to be fitted over the square headed rail bolts positioned in a non-alternating rail bolt arrangement, as shown in U.S. Pat. No. 510,501 (Doane). Clips are provided to hold the frame in place, and a bendable section is included to allow for expansion and contraction of the rails. However, alignment of the rail bolt nuts to fit the frame is not always easily obtained, and the clips used will not hold the frame is place over an extended period of time. Moreover, if the frame became loose, the flying steel frame can be dangerous to the rail car or bystanders.

Another approach was to provide a locking bar over a modified fishplate in order to hold the rail bolts in place, as shown in U.S. Pat. No. 1,517,001 (“Fuller”). However, this requires modification of the joint bars in use, and involves excessive installation time.

Other approaches involve the use of modified rail bolts, as shown in U.S. Pat. No. 166,379 (“Hipkins et al.”) or U.S. Pat. No. 442,455 (“Penrose”), or involve the use of modified locking devices such as those shown in U.S. Pat. No. 403,132 (“Penrose”), U.S. Pat. No. 992,647 (“Estes”), U.S. Pat. No. 1,160,389 (“Deise”), or U.S. Pat. No. 2,257,863 (“Olds”). However, while these devices and approaches have been known for some time, none of these currently have any significant usage in the railway industry. Typically, they are excessive costly, time-consuming, overly complex or the like, in order for them to be adopted for widespread use.

To overcome these difficulties, it would be advantageous to provide a rail bolt nut locking device that provides assistance in preventing, lessening or ameliorating any possibility of the rail bolt nut rotating to the point where the frog or joint bar becomes ineffective, and allows the frog or rail to move, or for adjacent rail sections to move.

It would be additionally advantageous to provide such a device which can also prevent movement of one or more rail bolts, if loosened.

It would be further advantageous to provide a rail bolt nut locking device which aids in showing any rotational movement of the nut, or inadvertent retraction by the bolt, from the frog or the rail and joint bar assembly of a rail bolt nut.

It would be even more advantageous to provide such a device which is low cost, easily installed, easily inspected, can withstand normal environmental conditions for extended time periods, and which would not present a hazard if accidentally dislodged.

### SUMMARY OF THE INVENTION

Accordingly, it is a principal advantage of the present invention to provide a rail bolt nut locking device which reduces, and aids in resisting any rotational movement of the rail bolt nut.

It is a further advantage of the present invention to provide a rail bolt nut locking device which provides an indication of rotational movement of the rail bolt nut.

It is a still further advantage of the present invention, to provide a rail bolt nut locking device which is low cost, easily used, and easily inspected by a maintenance crew member, or the like, which can withstand normal environmental conditions for extended time periods, and which would not present a hazard if accidentally dislodged.

It is an even still further advantage of the present invention to provide a rail bolt nut locking device which can assist in preventing at least one adjacent rail bolt from inadvertently retracting from the frog or from the rail and joint bar assembly.

The advantages set out hereinabove, as well as other objects and goals inherent thereto, are at least partially or fully provided by the rail bolt nut locking device of the present invention, as set out herein below.

Accordingly, in one aspect, the present invention provides a rail bolt nut locking device comprising a member, preferably made of plastic, having a first planar section at one end of the member, and a second planar section at an opposite end of the member, and wherein each of said first and second planar sections are substantially flat but each having openings adapted to be friction fitted around the preferably square or hexagon rail bolt nuts of first and second rail bolts, and wherein, said first and second planar sections are separated by at least one curved, resilient intermediate section which allows relative movement of the first and second planar sections.

The resilient nature of the intermediate section allows relative movement of the first and second planar sections in order to allow them to be fitted around, within the plane of the first or second planar sections, the first and second rail bolt nuts. However, the intermediate section should also be rigid enough that the locking device retains its shape, and does not allow or permit bending of the device, under its own weight.

The curved section in the curved intermediate section is provided so that, in use, a concave section is formed between the intermediate section and frog, or the joint bar. In joint bar applications, and wherein the head of a medial rail bolt, located between the first and second rail bolt nuts, can be accommodated, behind the intermediate section. Preferably, the concave section is formed so that the top of the medial rail bolt head, in use, is less than 10 cm from the curved intermediate section. More preferably, the concave section is such that the medial rail bolt head, in use, is between 0.25 and 5 cm, and more preferably, between 0.5 and 2.5 cm from the medial rail bolt head.

In this position, the curved intermediate section acts to prevent the medial rail bolt from retracting from the joint bar and rail assembly, should its rail bolt nut inadvertently become detached.

By providing a concave section in the curved intermediate section, the openings in the first and second planar sections can be fitted around the nuts of the ends of adjacent rail bolt nuts, in an alternating rail bolt pattern, as previously discussed.

Other than being curved, the intermediate section is preferably an essentially ribbon-like section although any suitable shapes might be used. This includes other shapes such as stranded or bar shaped structures, tube-shaped structures, concertina-like structures, or the like.

In frog applications, the nuts are typically all located on one side of the rail section. As such, the use of a medial bolt is not common. Also, the rail bolts are closer together. Accordingly, in frog applications, the intermediate section is shorter, and typically curved to allow flexing of the device in the rail bolt nut section of the frog.

In either application, by placing the rail bolt nuts in the openings of the device of the present invention, the nuts are not allowed to rotate since this would also require rotational movement of the rail bolt locking device. This is not possible, since the device is also attached to an adjacent nut. As a result, since the nut cannot rotate, the nut is prevented from loosening on the rail bolt.

Additionally, by providing the concave section, the medial rail bolt is prevented from retracting, or backing out of, its rail and joint bar holes, since the head of the rail bolt will still be held in place, and provide some support for the connection assembly, even if its rail bolt nut should become dislodged. This is particularly relevant for a rail bolt that includes a shoulder section locked into a correspondingly shaped hole in a joint bar since the intermediate section will hold the rail bolt in place so that the shoulder section still engages the joint bar hole.

Preferably, the rail bolt nut locking device will have a total of two openings adapted to be fitted around two adjacent rail bolt nuts. In joint bar applications, the openings are preferably adapted to be fitted around two adjacent rail bolt nuts, in an alternating rail bolt pattern. This is particularly relevant for a 4-hole joint bar wherein two rail bolt nuts will typically be positioned on each side of the rail. For a 6-hole joint bar, the rail bolt nut locking device previously described, can be used to be attached to any 2 of the two adjacent rail bolt nuts on each side of the rail.

However, this does not exclude the possibility that the rail bolt nut locking device can be installed on rail bolts which are not presented in an alternating pattern, such as on a frog, and instead, a system wherein adjacent rail bolt nuts are presented on the same side of the rail. Modification of the device may be necessary to adjust to the spacing between the openings.

In one possible alternative embodiment, however, the rail bolt nut locking device for use with joint bars, can also comprise an additional third flat planar section, with a further opening for a rail bolt nut, and a further, curved intermediate section, that allows it to be connected to all three rail bolt nuts on each side of the rail, in an alternating rail bolt pattern.

The locking device is preferably made of any acceptable materials, or any suitable combination of materials, that will provide the requisite functionality for this device. This includes plastic or metal materials, or combinations thereof. Most preferably, however, the locking device is manufactured completely from plastic, by, for example, injection- or blow-molding or the like. Suitable plastics include polyethylene, polypropylene, or the like, or any plastics capable of withstanding the environmental conditions typically encountered. The material selected should also be preferably able to provide suitable properties over an extended temperature range that might be encountered in a rail setting, such as, for example, temperatures of between −40° C. to +60° C., or even temperatures as high as 120° C., or the like.

The locking devices of the present invention can be made of a bright, highly visible plastic material which allows them to be easily seen, even under low lighting conditions. This allows the condition of the rail bolt nuts to be easily and rapidly checked on a regular basis. However, to avoid vandalism or the like, the locking devices can also be made of a dark coloured plastic material, that allows them to blend into the appearance of the joint bar, but still be clearly visible to a trained inspector.

The flexible, resilient connection section is preferably sufficiently rigid so as to assist in minimizing movement of the rail bolt nuts, but is still flexible enough to allow the device installer to bend, twist, and/or flex the device in order to fit over adjacent nuts. The openings can be circular, and friction fitted around the rail bolt nuts. More preferably though, the openings on the locking device are square or hexagonal to fit around the nut. Most preferably though, each opening includes a series of “teeth” which are adapted to fit around and hold against the exterior of either of the square or hexagon shaped nuts. This most preferred approach allows the device of the present invention to be more easily fitted to an already tightened bolt without the need to move or position the bolt further in order to have it move to the preset configuration necessary for a steel frame device of the prior art, or the like.

In a further aspect, the present invention also provides a method for reducing the amount of rotational movement of adjacent rail bolt nuts by placing one or more locking devices of the present invention, on a series of at least two adjacent rail bolt nuts, in the manner herein described.

In a still further aspect, the present invention also provides a rail bolt nut locking system comprising placing a plurality of rail bolt nut locking devices of the type described herein, around at least two sets of two rail bolt nuts on each side of a rail.

### DETAILED DESCRIPTION OF THE INVENTION

In the present application, the term “rail” refers to one or more of the rails used in the production of a railway line. This can include light rail or heavy rail applications. This can also include other railway-like assemblies including crane rails, or the like, or any other similar types of overhead rail systems. As such, while the present application is primarily directed to be used with rail bolts in a railway line, the skilled artisan will be aware that the rail bolt nut locking device of the present invention is capable of being used in a wide variety of applications.

Moreover, for clarity, in the present application, the term “rail bolt nut” refers to the nut which is used to hold a rail bolt in place, when used as part of a frog attachment system, or as part of a rail joint bar connector, used in a rail connection assembly.

### BRIEF DESCRIPTION OF THE DRAWINGS

Embodiments of this invention will now be described by way of example only in association with the accompanying drawings in which:

FIG. 1 is a perspective view of a rail connection assembly according to the prior art, including the ends of two rail sections, and two 4-hole joint bars with 4 rail bolts;

FIG. 2 is a cross-sectional view of the assembly of FIG. 1;

FIG. 3 is a perspective view of a 4-hole joint bar, and a rail bolt, according to the prior art;

FIG. 4 is a front view of a rail bolt nut locking device of the present invention;

FIGS. 5 to 7 are a side view, an end view and a back view, respectively, of the rail bolt nut locking device of FIG. 4;

FIGS. 8 and 9 are perspective front and back views of the device of FIG. 4;

FIG. 10 is a perspective view of the rail connection assembly of FIG. 1, which additionally includes the rail bolt nut locking device of FIG. 4, located on each side of the rail;

FIG. 11 is a top view of the assembly shown in FIG. 10;

FIG. 12 is a perspective view of a rail connection assembly having a 6-hole joint bar connection, and the rail bolt nut locking device of FIG. 4, located on each side of the rail;

FIG. 13 is a top view of the assembly shown in FIG. 12;

FIGS. 14 and 15 are perspective and top views of an alternative arrangement of a rail connection assembly having a 6-hole joint bar connection, and the rail bolt nut locking device of FIG. 4, located on each side of the rail;

FIG. 16 is a perspective view of an alternative embodiment of a rail bolt locking device of the present invention;

FIG. 17 is a top view of a rail connection assembly having a 6-hole joint bar connection, and two of the alternative embodiment of the rail bolt nut locking devices of FIG. 16;

FIG. 18 is a top view of a rail frog;

FIG. 19 is a top perspective view of the rail nut locking device, for use on frog sections;

FIG. 20 is a side view of the device shown in FIG. 19;

FIG. 21 is a bottom view of the device of FIG. 19; and

FIG. 22 is a perspective view of the device of FIG. 19 attached to two adjacent nuts on a frog.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

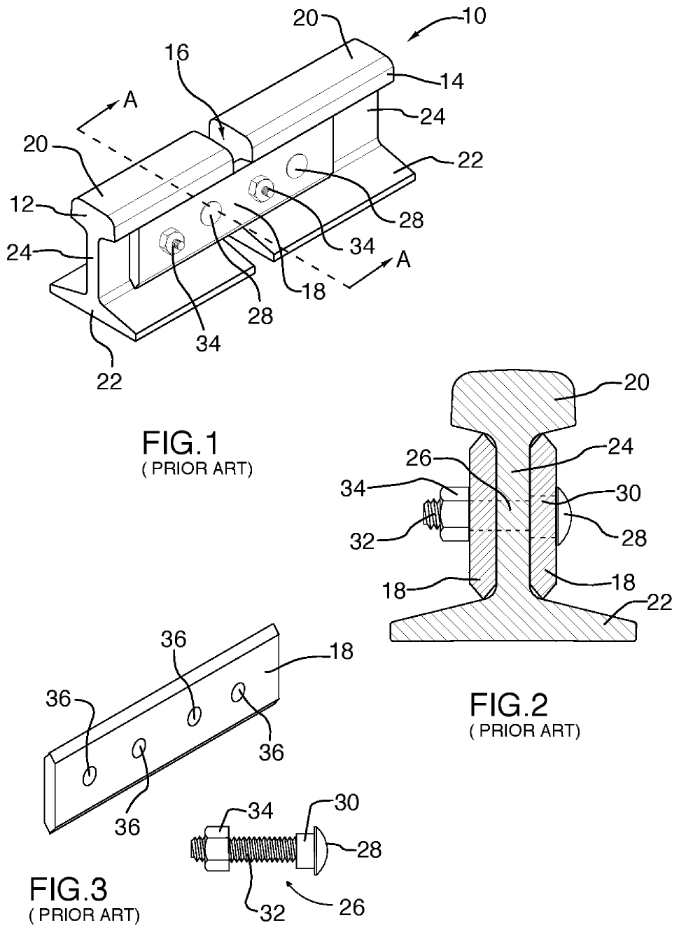

Referring to FIGS. 1 to 3, a rail line connection according to the prior art, and generally depicted as item 10, is shown in FIG. 1, and includes the ends of two steel rail lines 12 and 14 which are in abutment with one another. Each rail 12 and 14 has a rail head section 20, a foot section 22, and a web section 24 that sits between rail head 20 and foot 22. A small gap 16 is established between rails 12 and 14. A four-bolt, steel joint bar 18 is seated under rail head section 20, and primarily against the web section 24 on both sides of rails 12 and 14. Both joint bars 18 on each side of rails 12 and 14, span across gap 16.

Four rail bolts 26 are used to hold joint bars 18 in place with rail bolts 26 being placed through the four openings 36 in both of the joint bars 18 on either side of rails 12 and 14, and through the two openings provided in the web sections 24 of each of rails 12 and 14. FIG. 2, which is a cross-sectional view along line “A-A” of FIG. 1, shows the installation of one rail bolt 26 through the two joint bars 18 located on both sides of rail 12.

The details of the rail joint bars 18, and the rail bolts 26 are seen in FIG. 3, and it can be seen that, in this embodiment, rail bolts 26 have a rounded head section 28, an oval shoulder section 30, and a threaded section 32 which is adapted to receive nut 34. Rail joint bars 18 include four openings 36 which have a slightly oval shape and which are adapted to receive the oval shoulder section 30 of rail bolt 26.

While the rail bolts 26 can be installed all on the same side of rail joint bars 18, in this particular embodiment, rail bolts 26 are installed in an alternating pattern meaning that the rail bolts 26 are installed so that heads 28 alternate between the two sides of the rail (12, 14). Consequently, the nuts 34 are also positioned in an alternating pattern on the two sides of the rail (which is the combination of rail sections 12 and 14). As such, two nuts 34 and two heads 28 are located on each side of the rail (12, 14), with one head 28 being positioned in a medial location so as to be located between the two nuts 34 on each side. A further head 28 located one end or the other of the joint bars 18. In this arrangement, the two heads 28 are located in the first and third openings 36 in the rail joint bar 18 on one side of the rail (12, 14), and in the second and fourth openings 36 in the rail joint bar 18 on the other side of the rail (12, 14). Nuts 34 are positioned in the opposite arrangement.

It will clear to the skilled artisan that the shape and design of the rails, rail joint bars and rail bolts can vary, and that there are currently numerous modified designs for rail joint bars, and rail bolts. However, it will also be clearly understood by the skilled artisan that the ends of rail lines have been joined together in the manner generally shown in FIG. 1, for numerous years. In particular, the present invention is of primary use when rail bolts 26 are installed in an alternating pattern.

As previously described though, nut 34 on any or all of the rail bolts 26 is susceptible to loosening as a result of vibration, temperature fluctuations, and the like, and loosening of nuts 34 can result in loosening of the rail joint, and/or misalignment of the ends of rails 12 and 14. This can lead to derailment of any train passing over this compromised rail joint.

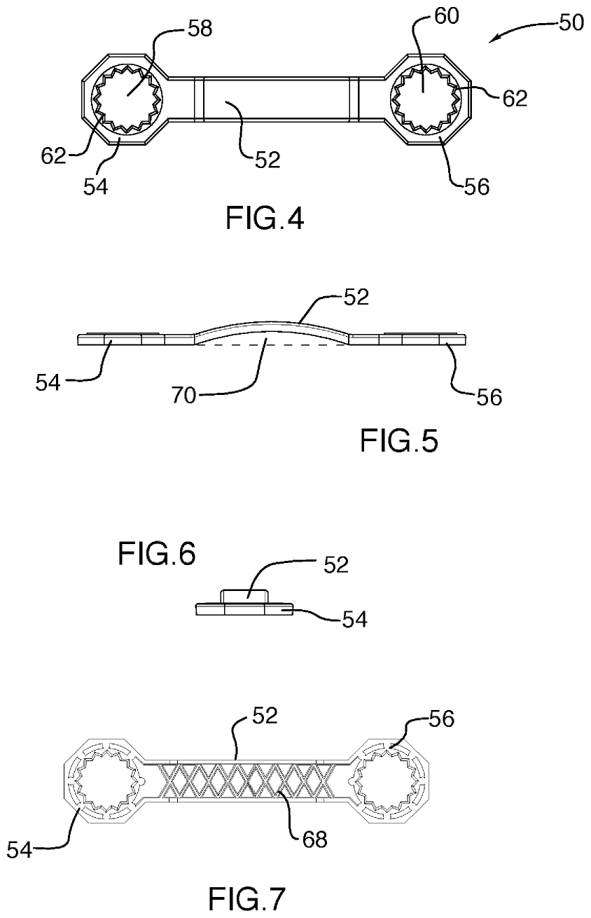

To reduce the likelihood of nut 34 loosening, or to ameliorate the effect of nuts 34 loosening, the present invention provides a rail bolt nut locking device 50, as shown in FIGS. 4 to 9, to prevent movement of nuts 34. Locking device 50 is preferably made of a resilient plastic, such as polyethylene or polypropylene, or other plastic capable of withstanding the rigorous environmental conditions, and features a central, ribbon shaped section 52 with a first substantially planar section 54, and a second substantially planar section 56 located at each end of ribbon shaped central section 52. Each of the first and second planar sections (54, 56) has an opening, 58 and 60, respectively. Around the perimeter of openings 58 and 60, are a series of “teeth” 62, which are provided to engage, in use, nuts 34. Teeth 62 can be beveled so that it is easier to place the device 50 on nuts 34, while providing a tightening effect by friction fit, as the device is pressed onto the nut.

Central section 52, as shown, is a thin, flat section which is generally in the shape of an arc. The front of central section 52 is shown as being smooth, as seen in FIG. 4, while the back of central section 52 can include reinforcing ribs 68, as shown in FIG. 7. Central section 52 is preferably semi-rigid which means that it can be bent, twisted or flexed, to a certain degree during installation, but remains sufficiently rigid during use to prevent nuts 34 from moving, or in general, prevent unwanted movement of device 50 caused by the normal forces acting on nuts 34.

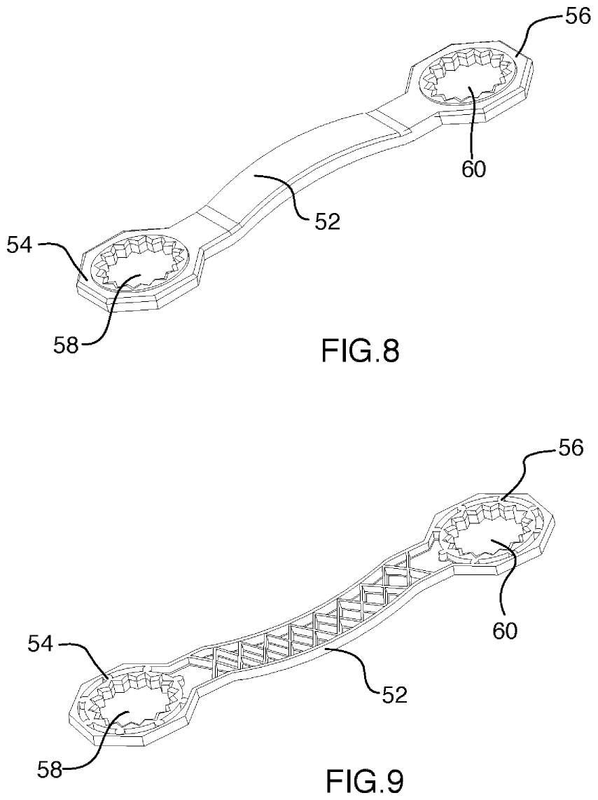

The arc in central section 52, as seen in the side view of FIG. 5, creates a concave opening, generally depicted as area 70. This arc can also be seen in the end view shown in FIG. 6, and can also be seen in the front and back perspective views shown in FIGS. 8 and 9.

The overall length of device 50 can vary depending on its particular application. Normally, the distance between openings in joint bars 18 are known, and device 50 is constructed so that openings 58 and 60 will generally align with every second joint bar openings (to establish an alternating rail bolt pattern). Typically, device 50 is between 20 and 120 cm long, and most typically, between 30 and 100 cm long although this can vary depending on the application. Generally, the width of device 50 is between 2 and 6 cm, and the thickness of the sections is between 1 and 5 cm.

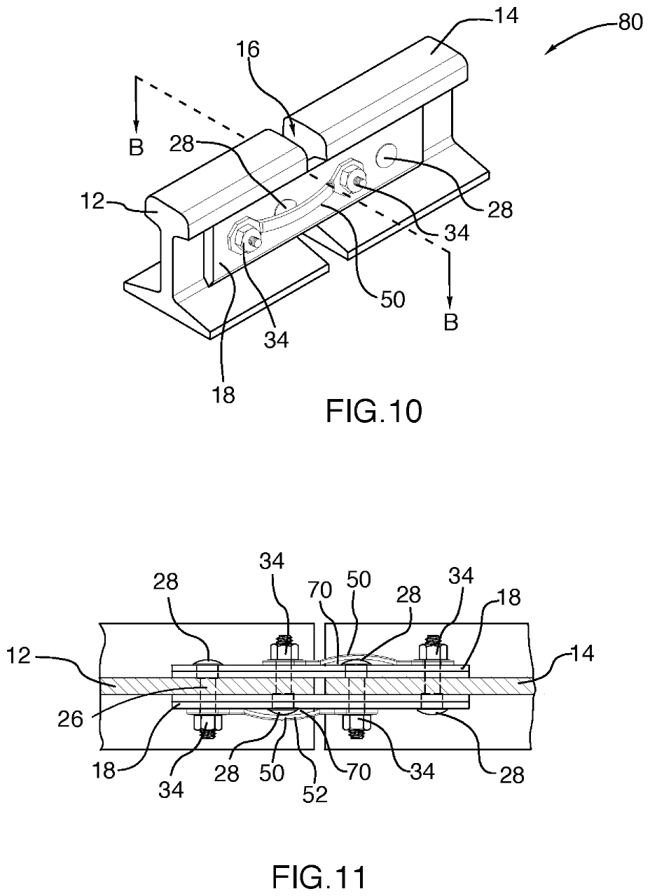

FIGS. 10 and 11 show a modified rail joint system 80 wherein two rail bolt nut locking devices 50 according the present invention, have been installed on the rail bolt nuts 34 of the rail connection arrangement 10 shown in FIG. 1. As can be seen in FIG. 10, one device 50 is installed on each side of the rail (12, 14), and openings 58 and 60 are fitted around first and second nuts 34 located on each side of the rail (12, 14), using teeth 62. Concave area 70 is located between central section 52 and the rail bar 18, and thus creates an area in which the head 28 of the intervening rail bolt 26, is placed. This area 70 is preferably sized so that central area 52 is immediately adjacent to head 28. In a preferred embodiment, when device 50 is installed, head 28 is positioned within 0 and 5 cm, and more preferably, 0.1 and 1 cm, of the central section 52. Central area 52 can contact head 28 (i.e. gap is 0 cm), but this contact should not result in any significant force that might cause nuts 34 to be forced out of openings 58 and 60.

A second device 50 is installed on the other side of the rail (12, 14), as is seen in FIG. 11 (which is a cross-sectional view along line “B-B” of FIG. 10).

To install devices 50, the device is held over the appropriate rail bolt nuts 34, in a position close to its final position. One opening 58 is fitted over one nut 34 and pressed into place so that teeth 62 engage nut 34. The resilient nature of the locking device material allows central section 52, to be slightly flexed or rotated if necessary so that the teeth 62 of opening 60 are aligned with nut 34 of the alternating rail bolt. The second end of device 50, with opening 60 is then also pressed into place. Thus, the task of installing device 50 can be easily accomplished within a few seconds, and devices 50 can be easily and quickly installed on the rail bolt nuts 34, on both sides of rail (12, 14), in a short time period.

It should also be noted, that by placement of head 28 within area 70, and close to central area 52, rail bolt 26 is prevented from backing out of the holes in the joint bar or rail.

Also, when two of devices 50 are fitted in place on each side of the rail, rail bolt nuts 34 are now positioned within openings 58 or 60 of both devices 50. As a result, both of devices 50 are prevented from rotating to any significant degree, and each nut 34 in devices 50 are held in their tightened position. Furthermore, for each device 50, at least one bolt head 28 is positioned within area 70, and is in contact with, or adjacent to, central section 52. In this arrangement, even if the nut 34 for that rail bolt 26 was to loosen, bolt 26 could not back out of the holes in joint bars 18 and rail sections 12 or 14 since it would be held in place by central section 52. As a result, rail bolts 26 are at least held in position, and as a result, the overall chances of the failure of the modified rail joint system 80, is reduced.

Moreover, in use, any loosening of a nut 34 would be initially prevented by the resistance to movement by the resilient nature of device 50. As such, the amount of rotational movement of the nuts 34 would be minimized. However, should nut 34 begin to loosen due to excessive forces, it will ultimately deform the shape of central section 52, so as to be easily visible by the operator on inspection. This deformation would be observable by a railway maintenance crew, who would be able to investigate the cause of the loosening of nut 34 and apply whatever corrective measures would be necessary to prevent total loosening of nut 34. Short of a catastrophic failure of central section 52, the resilient nature of device 50 of the present invention thereby acts to prevent complete loosening of nuts 34, and/or at least provides notification of such loosening to the operator. However, in normal applications, since nuts 34 are essentially prevented from any significant rotation by device 50, the likelihood of a total release of nuts 34 is virtually eliminated.

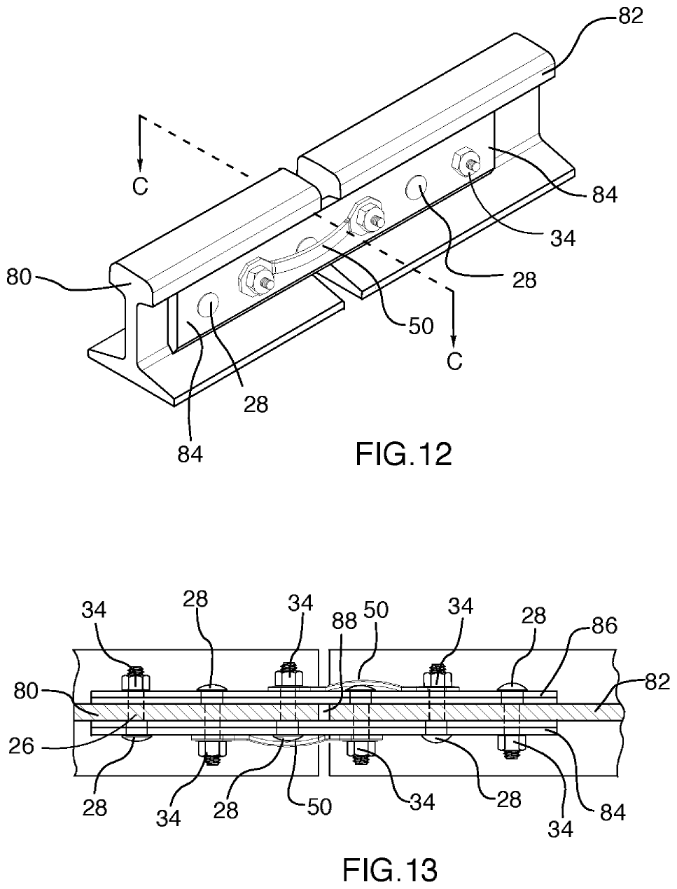

In FIG. 12, which is a perspective view, and FIG. 13, which is a cross-sectional view along line “C-C” of FIG. 12, an alternative use of device 50 is shown on a 6-hole joint bar. In this application, rail sections 80 and 82 are joined to create a rail (80, 82). Two six-hole joint bars 84 and 86 are positioned on each side of the rail (80, 82). Rail bolts 26 of the same type previously described, have been used to attach rail bars 84 and 86 to the rail (80, 82), in an alternating bolt pattern. Two devices 50 have been installed over first and second nuts 34 of alternating bolts, with a device 50 being located on each side of the rail (80, 82), in a manner that both of devices 50 span the gap 88 between rail sections 80 and 82.

In the approach shown in FIGS. 12 and 13, not all nuts 34 are covered by, or attached to, device 50. However, at least 4 nuts 34 for the 6 rail bolts 26, are protected from loosening by devices 50 of the present invention.

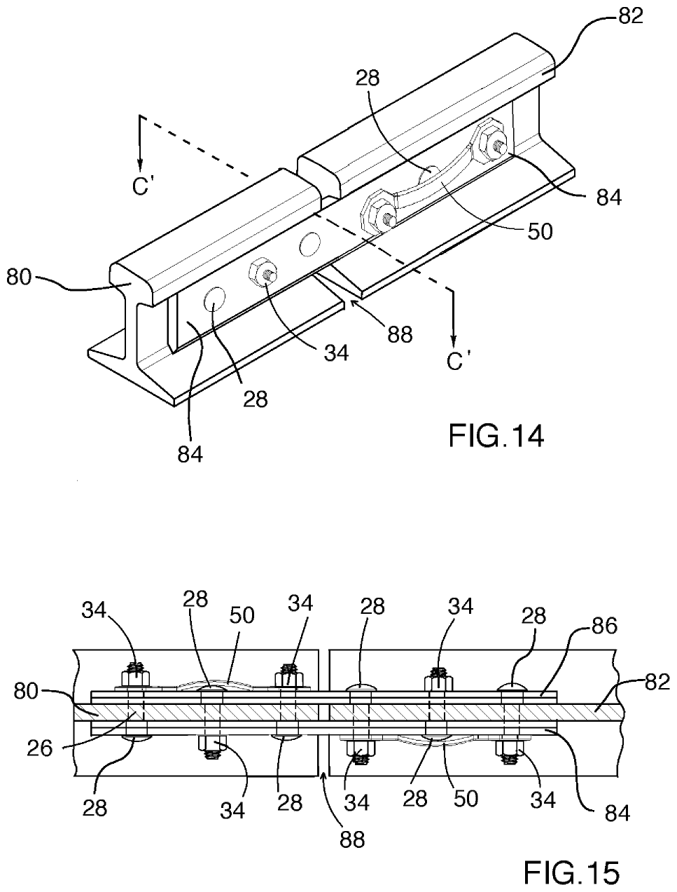

It will also be noted that devices 50 span the gap 88 between rail sections 80 and 82. This approach is not always needed, and as such, in an alternative embodiment, two devices 50 can be positioned in the arrangement shown in FIGS. 14 and 15 wherein FIG. 14 is a perspective view similar to FIG. 12, and FIG. 15 is a cross-sectional view along line “C′-C′”. In this approach however, devices 50 are connected to the two nuts 34 located at the end of rail bars 84 and 86 in a manner so that devices 50 do not span gap 88. One benefit of this approach is that all six rail bolts 26 are either attached to device 50, by having device 50 directly connected to nuts 34, or have their heads 28 positioned within the arced area 70 in devices 50.

Additionally, multiple devices 50 might be used on each side of the rail. In this approach, two of devices 50 might be attached to a single nut, in order to connect all nuts to a device 50.

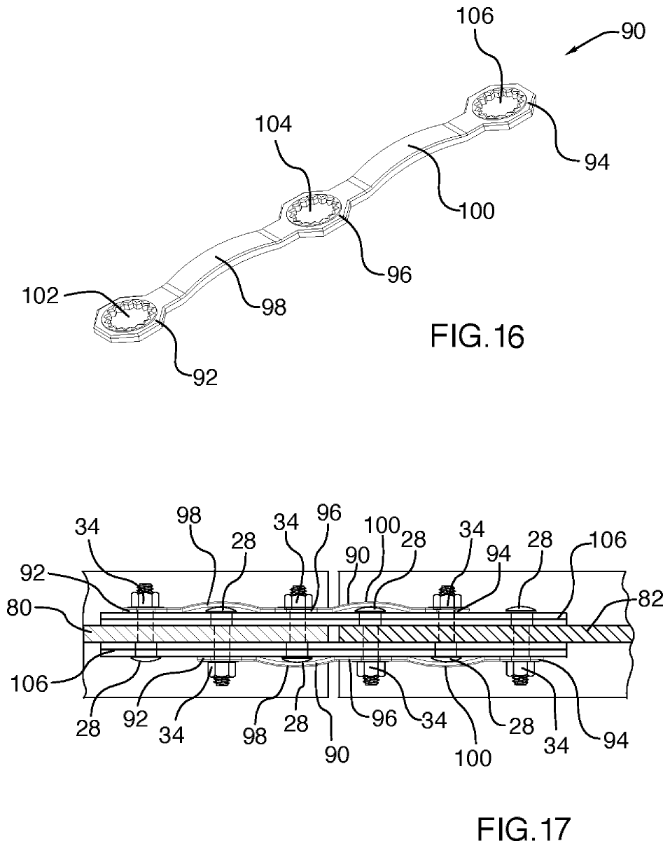

Alternatively, in FIG. 16, a perspective view of an alternative embodiment of the device of the present invention is shown. In this embodiment, a modified linear device 90 is used having a first substantially planar section 92 at one end, a second substantially planar section 94 at the other end, and a central substantially planar section 96 located between sections 92 and 96. Openings 102, 104 and 106 are provided in each planar section, and these openings include “teeth” for use for connection to the nuts 34 of rail bolts 26. Two ribbon shaped sections 98 and 100 connect the first substantially planar section 92 to the central substantially planar section 96, and connect the second substantially planar section 94 to central substantially planar section 96. Both ribbon shaped sections 98 and 100 include an arc structure, as previously described.

Two of these devices 90 are used to be fitted over the six bolts in a six-hole rail bar 106, in the manner shown in FIG. 17 with one rail bar 106, and one device 90 being located on each side of the rail (80, 82). In use, devices 90 are fitted to nuts 34 of the first, second and third rail bolts, on each side of rail (80, 82), in a manner similar to that previously described. The distances between the openings 102, 104, and 106 are configured to align with the holes provided in the rail bars.

In the top view of FIG. 17, which is a cross-sectional view similar to those shown in FIGS. 11, 13 and 15, it can also be noted that all nuts 34 are now attached to devices 90 and the heads of four of the bolts 28 are covered by the arced ribbon shaped sections 98 and 100. This aids in preventing all of the bolts in a six-hole rail bar from loosening and/or backing out of the holes in the rail or rail bars.

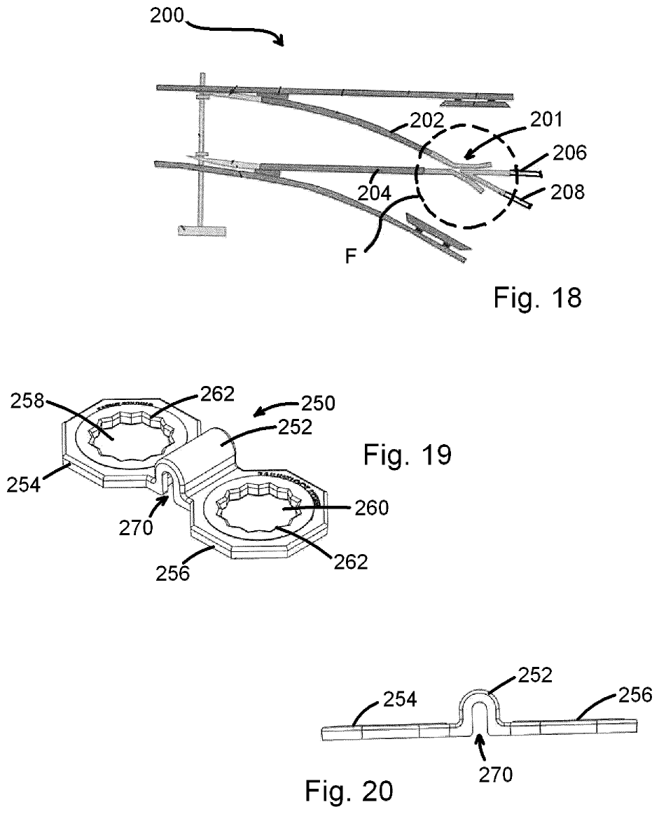

In FIG. 18, the switch area of two railway tracks, generally depicted as 200, is shown. The frog 201 is generally shown in area “F”, and it is connected to rails 202, 204, 206 and 208, by use of rail bolts and nuts, in a manner similar to that shown in FIG. 1, or as shown in FIG. 22. Devices 210 or 250, discussed hereinbelow, are used to hold the nuts, and bolts, in place.

As seen in FIGS. 19 to 21, rail bolt locking device 250 is preferably made of a resilient plastic, such as polyethylene or polypropylene, or other plastic capable of withstanding the rigorous environmental conditions, and features a ribbon shaped central section 252 with a first substantially planar section 254, and a second substantially planar section 256 located at each end of ribbon shaped central section 252. Each of the first and second planar sections (254, 256) has an opening, 258 and 260, respectively. Around the perimeter of openings 258 and 260, are a series of “teeth” 262, which are provided to engage, in use, the nuts holding the frog together or in place.

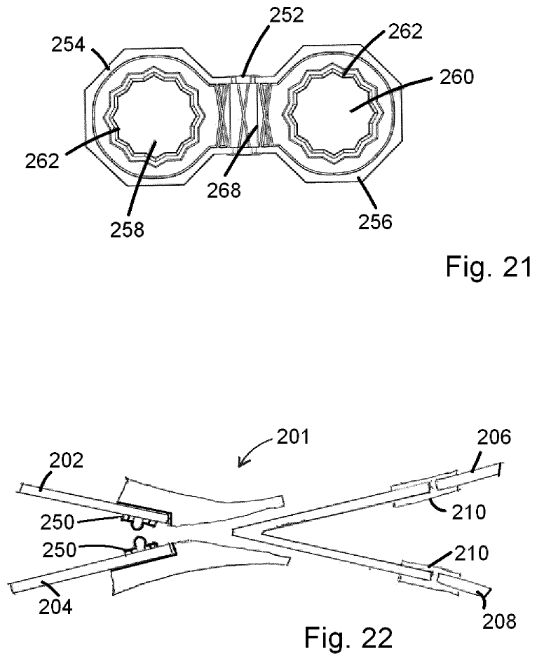

Central section 252, as shown, is a thin, flat section which is generally in the shape of an arc. The front of central section 252 is shown as being smooth, as seen in FIG. 19, while the back of central section 252 can include reinforcing ribs 268, as shown in FIG. 21. Central section 252 is preferably semi-rigid which means that it can be bent, twisted or flexed, to a certain degree during installation, but remains sufficiently rigid during use to prevent nuts contained therein, from moving.

The arc in central section 252, as seen in the side view of FIG. 20, creates a concave opening, generally depicted as area 270. It will be noted that the arc in device 250 is much more pronounced than the arc in the device shown in FIG. 5.

It is also to be noted that the overall length of device 250 can vary depending on its particular application. Normally, the distance between openings in the frog 200 are known, and device 250 is constructed so that openings 258 and 260 will generally align with the openings in the frog. Typically, device 250 is between 10 and 30 cm long, and most typically, between 15 and 20 cm long although this can vary depending on the application. Generally, the width of device 250 is between 2 and 6 cm, and the thickness of the various sections is between 1 and 5 cm.

FIGS. 19 to 21 shows a frog nut device 250 for use when the nuts are located on one side, and the distance between nuts can be smaller than those shown in, for example, the device shown in FIG. 10. One or two devices 250 can be installed on one side of the rail, in order to lock the rail bolt nuts in position, in a manner similar to the devices previously described.

FIG. 22 shows a frog 201 which is connected to rail sections 206 and 208 using a normal joint bar connections 210 in the manner previously described. Rail sections 202 and 204 extend into, and lay adjacent to portions of frog 201. Bolt holes (not shown) are provided in frog 201 and rail sections 202 and 204 in order to allow rail bolts to be passed through both, and tightened using suitable nuts and bolts. Bolt lock 250 is used to hole the nuts for the rail bolts tightly in position, and prevent the nuts and bolts from loosening.

Thus, it is apparent that there has been provided, in accordance with the present invention, a rail bolt nut locking device which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

What is claimed is:

1. A rail bolt nut locking device comprising a member having a first planar section at one end of the member, and a second planar section at an opposite end of the member, and wherein each of said first and second planar sections are substantially flat but each having openings adapted to be friction fitted around the rail bolt nuts of first and second rail bolts, and wherein, said first and second planar sections are separated by at least one curved, resilient intermediate section which allows relative movement of the first and second planar sections.

2. A locking device as claimed in claim 1 wherein each of said openings comprises a series of teeth which are adapted to be fitted around the shoulders of a rail bolt nut, so as to provide said friction fit.

3. A locking device as claimed in claim 1 wherein said resilient intermediate section allows said section to be flexed, bent or twisted.

4. A locking device as claimed in claim 1 wherein said locking device is made from injection- or blow-molded plastic.

5. A locking device as claimed in claim 1 wherein said device is configured to be installed on rail bolts which have been installed in an alternating pattern from each side of the rail.

6. A locking device as claimed in claim 1 wherein said rail bolt nut is square or hexagon shaped.

7. A locking device as claimed in claim 1 wherein said locking member additionally comprises a further central planar section having an opening adapted to be friction fitted around a rail bolt nut, and said first and second planar sections are each attached to said central planar sections by curved, resilient intermediate sections which allows relative movement of the first and second planar sections.

8. A method for reducing the amount of rotational movement of adjacent rail bolt nuts in a rail joint bar, by placing one or more locking devices as claimed in claim 1, on at least two rail bolt nuts.

9. A method as claimed in claim 8 wherein each of said openings comprises a series of teeth which are adapted to be fitted around the shoulders of a rail bolt nut, so as to provide said friction fit.

10. A method for reducing the amount of rotational movement of adjacent rail bolt nuts in a frog, by placing one or more locking devices as claimed in claim 1, on at least two rail bolt nuts.

11. A method as claimed in claim 10 wherein each of said openings comprises a series of teeth which are adapted to be fitted around the shoulders of a rail bolt nut, so as to provide said friction fit.

12. A rail bolt nut locking system comprising placing a rail bolt nut locking devices as claimed in claim 1, around the nuts of at least two rail bolts, on at least one side of a rail.

13. A rail bolt nut locking system as claimed in claim 12 wherein each of said openings comprises a series of teeth which are adapted to be fitted around the shoulders of a rail bolt nut, so as to provide said friction fit.
